(19) United States
(12) Patent Application Publication
(10) Pub. No.: US 2010/0262732 A1
(43) Pub. Date: Oct. 14, 2010

(54) PERIPHERAL INTERFACE

(76) Inventors: Tony TSENG, Hsi-Chih (TW); Johnny Hsiang-yu CHEN, Anaheim, CA (US)

Correspondence Address: Guice Patents PLLC, 12647 Galveston Court #302, Manassas, VA, 20112, US

(21) Appl. No.: 12/754,829

(22) Filed: Apr. 6, 2010

(30) Foreign Application Priority Data
Apr. 13, 2009 (TW) 098112159

(51) Int. Cl. G06F 13/12

(52) U.S. Cl. 710/64

(57) ABSTRACT

The present invention relates to a peripheral interface, capable of being installed in a peripheral device to provide an operation interface, the peripheral interface having: a digital processor; a computer host input port; an input interface; and a display unit; wherein the peripheral device can receive at least one operation option entry from the input interface or the computer host.

### BACKGROUND OF THE INVENTION

1. Field of the Invention

The present invention relates to a peripheral interface, especially to an interface for a computer peripheral device.

2. Description of the Related Art

It is common that a computer peripheral device possesses a control means and a display device to facilitate local operations for users. For example, prior art printers are generally equipped with a display device and selection keys to provide a user interface for users to start/stop a print procedure or sleep mode timing. However, the user interface of the prior art printers has not yet provide operation options like setting the number of print pages, which are typically done on a computer host, and it can become particularly inconvenient when a user, near the printer but far away from the computer host, wants to set the number of print pages.

### SUMMARY OF THE INVENTION

The main objective of the present invention is to provide a peripheral interface to permit the print option entries, which originally could only be entered on a computer, to be inputted on a printer.

To accomplish the foregoing objective, the present invention proposes a peripheral interface, capable of being installed in a peripheral device to provide an operation interface, and capable of coupling to a computer host having a specific program and a display, the display being capable of providing a window picture when the specific program is executed by the computer host, the peripheral interface including: a digital processor; a computer host input port, having one end coupled to the computer host, and the other end coupled to the digital processor; an input interface, coupled to the digital processor, capable of receiving at least one operation option entry and conveying the at least one operation option entry to the digital processor; and a display unit, coupled to and controlled by the digital processor to show the window picture, wherein the peripheral device can receive the at least one operation option entry from the input interface or the computer host.

To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1 is a block diagram of a peripheral interface according to a preferred embodiment of the present invention.

FIG. 2 is an illustrative diagram showing a peripheral interface according to a preferred embodiment of the present invention installed in a printer, and connected to a computer host.

### DETAILED DESCRIPTION OF THE PREFERRED EMBODIMENTS

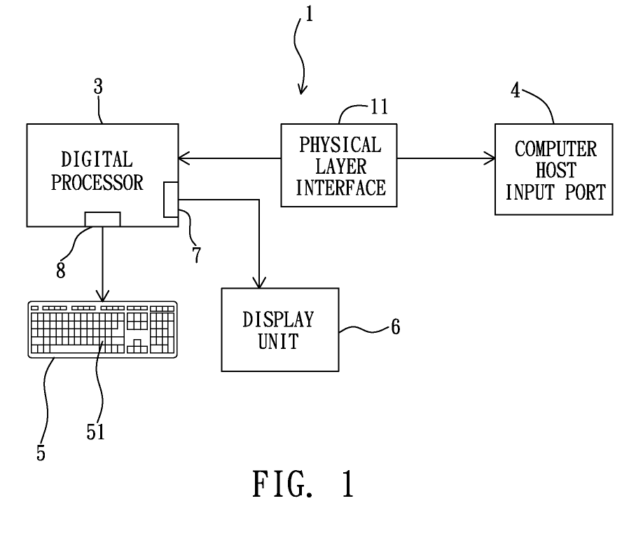

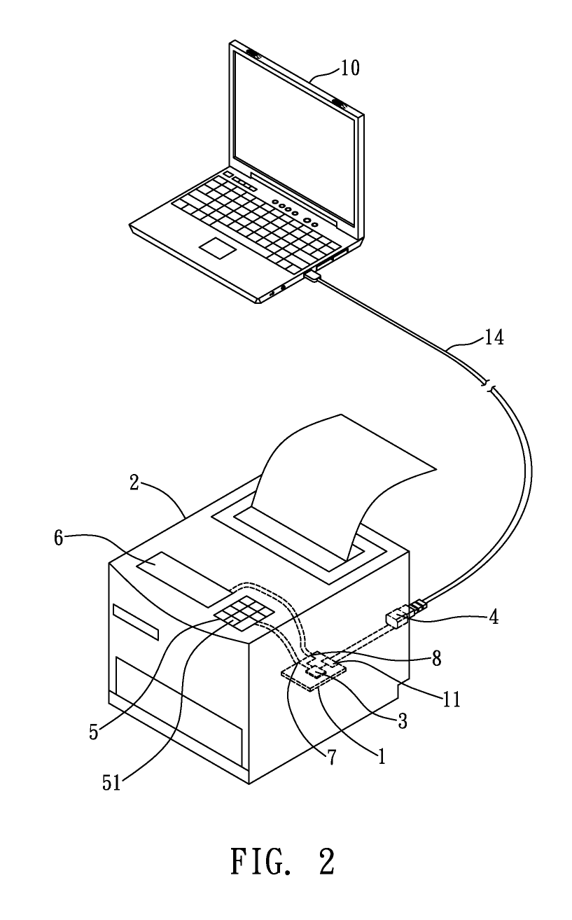

Please refer to FIG. 1 and FIG. 2 for cross reference, wherein FIG. 1 is a block diagram of a peripheral interface according to a preferred embodiment of the present invention and FIG. 2 is an illustrative diagram showing a peripheral interface according to a preferred embodiment of the present invention installed in a printer, and connected to a computer host.

The peripheral interface 1 is capable of being installed in a peripheral device 2—for example but not limited to a printer—to provide an operation interface, and capable of coupling to a computer host 10 having a specific program and a display (not shown in the figure), the display being capable of providing a window picture (not shown in the figure)—for example but not limited to a print operation window picture—, when the specific program is executed by the computer host 10. The computer host 10 can be, for example but not limited to, a desktop computer or a notebook computer or a portable electronic device, and in this embodiment, a notebook computer, not to limit the scope of the present invention, is taken as an example for illustration.

As shown in FIG. 1, the peripheral interface 1 includes: a digital processor 3; a computer host input port 4; an input interface 5; and a display unit 6.

In the peripheral interface 1, the digital processor 3, for example but not limited to an ASIC chip, can be programmed to perform the following functions: 1. receiving operation option entries from the computer host 10 to control the peripheral device 2, and driving the display unit 6 to display the operation option entries; 2. conveying at least one operation option entry from the input interface 5 to the computer host 10, so that the computer host 10 can communicate with the peripheral device 2 to execute the task specified by the at least one operation option entry.

The computer host input port 4, for example but not limited to a type B USB socket, can be connected to the computer host 10 with a wired connection or a wireless connection, wherein the wired connection is for example but not limited to connection through a USB cable 14, and the wireless connection is for example but not limited to CWUSB (Certified Wireless USB) connection. The computer host input port 4, installed in the peripheral device 2 and exposed outward, has one end coupled to the computer host 10 and the other end coupled to the digital processor 3.

The input interface 5 is coupled to the digital processor 3 through a GPIO (General Purpose Input Output) port 7, to receive at least one operation option entry and convey the at least one operation option entry to the digital processor 3. The input interface 5 is, for example but not limited to a keyboard having a plurality of keys 51, to provide an input means for users to input operation option entries.

The display unit 6, coupled to the digital processor 3 through another GPIO port 8, can be driven by the digital processor 3 to show the window picture (not shown in the figure). The display unit 6 is for example but not limited to a liquid crystal display, and the window picture is for example but not limited to a window picture for print operation.

Besides, the peripheral interface 1 further possesses a physical layer interface 11—for example but not limited to a USB physical layer interface—, coupled to the digital processor 3 and the computer host input port 4 respectively, to provide a physical layer signal transmission.

As shown in FIG. 2, when the peripheral interface 1 is in use, users can connect the printer 2 to the computer host 10 in a wired manner or a wireless manner. In this embodiment, a wired manner—connection through the USB cable 14—is utilized for illustration.

Then, by pressing Cntl-P on the keyboard of the computer host 10, the specific program will be actuated to display the window picture on the display of the computer host 10, and transmit the data of the window picture to the digital processor 3 of the peripheral interface 1 to display the window picture on the display unit 6. As such, users can input operation option entries, for example, the number of print pages, on the computer host 10 or the printer 2.

If users input an operation option entry relating to the number of print pages on the computer host 10, the operation option entry will be transmitted through the USB cable 14 to the printer 2, and the print task will be done accordingly; if users input the operation option entry on the printer 2, the operation option entry will be transmitted to the computer host 10, which, by executing the specific program, will identify the operation option entry, and then transmit the print task through the USB cable 14 to the printer 2, and the printer 2 will execute the print task accordingly.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A peripheral interface, capable of being installed in a peripheral device to provide an operation interface, and capable of coupling to a computer host having a specific program and a display, said display being capable of providing a window picture when said specific program is executed by said computer host, said peripheral interface comprising:
a digital processor;
a computer host input port, having one end coupled to said computer host, and the other end coupled to said digital processor;
an input interface, coupled to said digital processor, capable of receiving at least one operation option entry and conveying said at least one operation option entry to said digital processor; and
a display unit, coupled to and controlled by said digital processor to show said window picture, wherein said peripheral device can receive said at least one operation option entry from said input interface or said computer host.

2. The peripheral interface as claim 1, wherein said computer host is an electronic device selected from a group consisting of a desktop computer, a notebook computer and a portable electronic device.

3. The peripheral interface as claim 1, wherein said specific program is a print program.

4. The peripheral interface as claim 1, wherein said digital processor is an ASIC chip.

5. The peripheral interface as claim 1, wherein said computer host input port is a type B USB socket, coupled to said computer host with a wired connection or a wireless connection.

6. The peripheral interface as claim 5, wherein said wireless connection is CWUSB connection, and said wired connection is through a USB cable.

7. The peripheral interface as claim 1, wherein said input interface is a keyboard, having a plurality of keys.

8. The peripheral interface as claim 1, wherein said display unit is a liquid crystal display.

9. The peripheral interface as claim 1, wherein said peripheral device is a printer.

10. The peripheral interface as claim 1, further comprising a physical layer interface coupled to said digital processor and said computer host input port.

11. The peripheral interface as claim 9, wherein said window picture is a window picture for print operation, and said specific program is executed by pressing Cntl-P.
